(19) United States
(12) Patent Application Publication
(10) Pub. No.: US 2014/0188607 A1
(43) Pub. Date: Jul. 3, 2014

(54) ADVERTISING EXPOSURE METHOD BASED ON EVENT OCCURRENCE, SERVER FOR PERFORMING THE ADVERTISING EXPOSURE METHOD, AND COMPUTER-READABLE RECORDING MEDIUM HAVING RECORDED THEREON PROGRAM FOR EXECUTING THE ADVERTISING EXPOSURE METHOD

(71) Applicant: NAVER BUSINESS PLATFORM Corp., Seongnam-Si (KR)

(72) Inventor: Dong Hyeok YANG, Seongnam-si (KR)

(73) Assignee: NAVER BUSINESS PLATFORM CORP., Seongnam-Si (KR)

(21) Appl. No.: 14/135,948

(22) Filed: Dec. 20, 2013

(30) Foreign Application Priority Data
Dec. 27, 2012 (KR) 10-2012-0155085

(51) Int. Cl. G06Q 30/02

(52) U.S. Cl. CPC G06Q 30/0255; G06Q 30/0267
USPC 705/14.53

(57) ABSTRACT

Methods and systems of obtaining an advertisement based on event occurrence on a mobile terminal are provided. A desired event is determined to have occurred on the mobile terminal. Event occurrence information is generated. The event occurrence information may be associated with the desired event. A keyword is extracted, which is based on the generated event occurrence information. An advertisement is obtained that is based on the extracted keyword.

### RELATED APPLICATIONS

This application claims the benefit of Korean Patent Application No. 10-2012-0155085, filed on Dec. 27, 2012, in the Korean Intellectual Property Office, the disclosure of which is incorporated herein in its entirety by reference.

### BACKGROUND

1. Field

One or more example embodiments relate to an advertising exposure method based on an occurrence of an event, a server for performing the advertising exposure method, and a computer-readable recording medium having recorded thereon a program, that when executed, performs the advertising exposure method.

2. Description of the Related Art

According to the development of information and communication technologies, utilization ranges and the number of uses of mobile terminals are largely increasing. In detail, according to the supply of mobile terminals (e.g., “smart phones”, tablet personal computers (PCs), and the like) having a voice communication function, a network communication function (e.g., communicating via the Internet, and the like), and an information searching function, uses of various service applications installable and usable in the mobile terminals are increasing. The increased utilization ranges and increased frequencies of the mobile terminals allows for mobile application advertising schemes and/or models that provide advertisements using an application installed in the mobile terminals may be provided.

In current mobile application advertising schemes and/or models, an advertisement irrelevant to matters of interest to a user of a mobile terminal may be unilaterally shown through the application. Additionally, current mobile application advertising schemes and/or models also provide that an advertisement matched to a category of an application being currently executed on the mobile terminal is shown through the application. However, by using such current mobile application advertising, a click through rate (CTR) of the user is low since a degree of interest (need) of the user, suitability of the advertisement, and relevance of the advertisement to the user are low. In other words, using traditional targeted advertising schemes and/or models is difficult in current mobile application advertising.

Meanwhile, keyword advertising models may be used as a form of advertising model using the Internet. Based on an expectation that a user may be highly interested in a product or service by matching a keyword input to a search portal site by the user, the keyword advertising model provides an advertisement matching the input keyword on a certain region of a region providing a search result. In keyword advertising, details of the advertisement may also be provided, and thus an advertising effect may be obtained by exposing the user to the advertisement. Alternatively, an advertising effect may be obtained by providing details of the advertisement or connecting to a website related to the advertisement, according to selection (e.g., clicking and/or tapping) or a mouseover motion by the user. However, since the keyword advertising model is limitedly applied to cases when the user inputs a certain keyword, such as a search word. Thus, it is difficult to reflect or otherwise utilize various usage behaviors of the user. In detail, in the mobile terminal, there are usage behaviors of the user using desired functions by executing various applications installed in the mobile terminal, but it is not currently possible to provide advertisements related to events occurred according to execution of the applications and manipulation by the user while executing the applications.

### SUMMARY

According to an example embodiment, a method of providing an advertisement based on event occurrence on a mobile terminal is provided. The method includes determining that a desired event has occurred on the mobile terminal. The method includes obtaining event occurrence information. The event occurrence information may be associated with the desired event. The method includes extracting a keyword based on the generated event occurrence information. The method includes providing an advertisement based on the extracted keyword.

According to an example embodiment, a non-transitory computer-readable recording medium is provided, which has recorded thereon a program, that when executed, performs a method of providing an advertisement based on event occurrence on a mobile terminal. The method includes determining that a desired event has occurred on the mobile terminal. The method includes obtaining event occurrence information. The event occurrence information may be associated with the desired event. The method includes extracting a keyword based on the generated event occurrence information. The method includes providing an advertisement based on the extracted keyword.

According to an example embodiment, a system for providing an advertisement based on event occurrence at a mobile terminal is provided. The mobile terminal includes an event detecting module configured to determine that a desired event has occurred on the mobile terminal, and generate event occurrence information. The event occurrence information may be associated with the desired event. The mobile terminal includes a keyword extracting module configured to extract a keyword based on the generated event occurrence information. The mobile terminal includes an advertising exposure module configured to obtain, from a server, an advertisement based on the extracted keyword.

According to an example embodiment, a server configured to provide, to a mobile terminal, an application for obtaining an advertisement based on an event occurrence is provided. The application causes the mobile terminal to determine that a desired event has occurred on the mobile terminal. The application causes the mobile terminal to generate event occurrence information, the event occurrence information being associated with the desired event. The application causes the mobile terminal to extract a keyword based on the generated event occurrence information. The application causes the mobile terminal to obtain the advertisement from the server, the obtained advertisement being based on the extracted keyword.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram of an advertising exposure system based on event occurrence, according to an example embodiment;

FIG. 2 is a block diagram of a mobile terminal for performing advertising exposure based on event occurrence, according to an example embodiment;

FIG. 3 is a block diagram of an advertising exposure system based on event occurrence, according to an example embodiment;

FIG. 4 is a flowchart illustrating operations of an advertising exposure system based on event occurrence, according to an example embodiment; and

FIG. 5 is a flowchart illustrating operations of an advertising exposure system based on event occurrence, according to an example embodiment.

### DETAILED DESCRIPTION

The example embodiments are described more fully hereinafter with reference to the accompanying drawings, in which example embodiments are shown. These example embodiments may, however, be embodied in many different forms and should not be construed as limited to the example embodiments set forth herein. Rather, the example embodiments are provided so that this disclosure is thorough, and will fully convey the scope to those skilled in the art. In the drawings, the size and relative sizes of layers and areas may be exaggerated for clarity. Like reference numerals in the drawings denote like elements.

Example embodiments will now be described more fully with reference to the accompanying drawings in which example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments to those of ordinary skill in the art. In the drawings, the thicknesses of layers and areas are exaggerated for clarity. Like reference numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, areas, layers and/or sections, these elements, components, areas, layers and/or sections should not be limited by these terms. These terms are only used to distinguish one element, component, area, layer or section from another element, component, area, layer or section. Thus, a first element, component, area, layer or section discussed below could be termed a second element, component, area, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of areas illustrated herein but are to include deviations in shapes that result, for example, from manufacturing. For example, an implanted area illustrated as a rectangle will, typically, have rounded or curved features and/or a gradient of implant concentration at its edges rather than a binary change from implanted to non-implanted area. Likewise, a buried area formed by implantation may result in some implantation in the area between the buried area and the surface through which the implantation takes place. Thus, the areas illustrated in the figures are schematic in nature and their shapes are not intended to illustrate the actual shape of an area of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, one or more example embodiments of the present invention will be described in detail with reference to accompanying drawings, to be easily executed by one of ordinary skill in the art.

### Embodiments of the Present Invention

In one or more example embodiments of the present invention, a “mobile terminal” is not limited in its type as long as it is a digital device having an operation ability by including a memory device and a processor and/or microprocessor, supporting a data communication function through a mobile communication network or a wireless network, and having intrinsic identification information to be distinctively identified on a network. For convenience of description and understanding, a smart phone is used as the mobile device herein, but the mobile device is not limited thereto, and other mobile devices may be used.

Also, “keyword advertising” denotes an advertising exposure method for analyzing a query input by a user to determine a keyword, extracting an advertisement matching the determined keyword, and providing the advertisement with a search result and/or other like information on a user terminal. For convenience of description and understanding, the keyword advertising applied to a search advertisement is mainly described, but the keyword advertising is not limited thereto, and any one of various advertising systems matching and providing an advertisement by using a keyword may be used.

Also, an “event” is a term including all actions (for example, inputting of information, generating of information, executing of a function, outputting of information, and changing of a state) that may occur on a mobile terminal, and may be classified according to an occurrence of one or more operations, a user manipulation event based on one or more manipulations by a user, and a conditional event occurring when a desired (or alternatively, “desired”) condition is satisfied. It should be noted that the term “manipulation” may include any form of user interaction with an application and/or device. Such interactions may be received or otherwise detected using a mouse, keyboard, touchpad, stylus, touch screen, motion detection device, eye-tracking device, and/or any other like user interaction.

Structure and Functions of Advertising Exposure System Based on Event Occurrence according to Embodiment

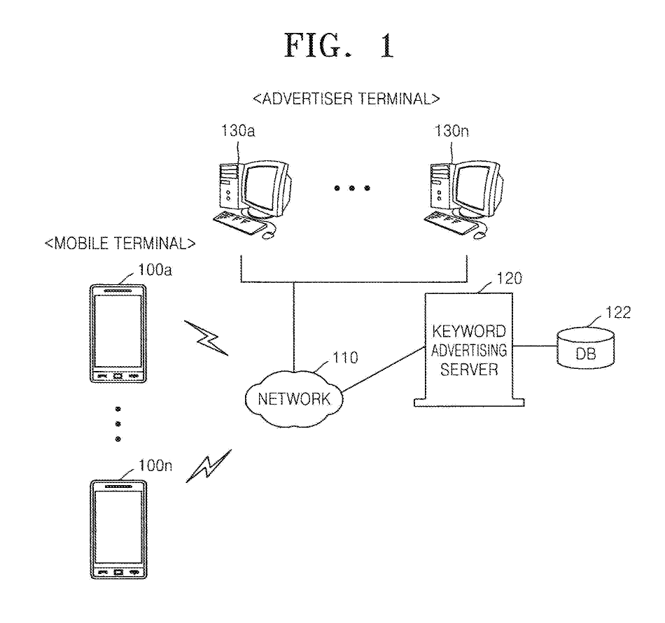

FIG. 1 is a block diagram of an advertising exposure system based on event occurrence, according to an example embodiment. A structure and functions of the advertising exposure system based on event occurrence according to the current embodiment will now be described with reference to FIG. 1.

As shown in FIG. 1, the advertising exposure system may include one or more mobile terminals 100a through 100n, a network 110, one or more advertiser terminals 130a through 130n, and a keyword advertising server 120.

According to various embodiments, mobile terminals 100a through 100n may be a hardware computing device capable of communicating with a server (e.g., keyword advertising server 120), such that each of the mobile terminals 100a through 100n are able to receive services from the server. The mobile terminals 100a through 100n may be configured to determine whether a desired event occurs, detect a type of the desired event if the desired event occurred, and transmit a keyword corresponding to generated event occurrence information (i.e., information for identifying the desired event) to the keyword advertising server 120. Also, the mobile terminals 100a through 100n may be configured to receive an advertisement corresponding to a keyword transmitted from the keyword advertising server 120 and expose the received advertisement on a desired certain region. An advertising exposure application 200 that will be described later may be installed in the mobile terminals 100a through 100n for performing such functions.

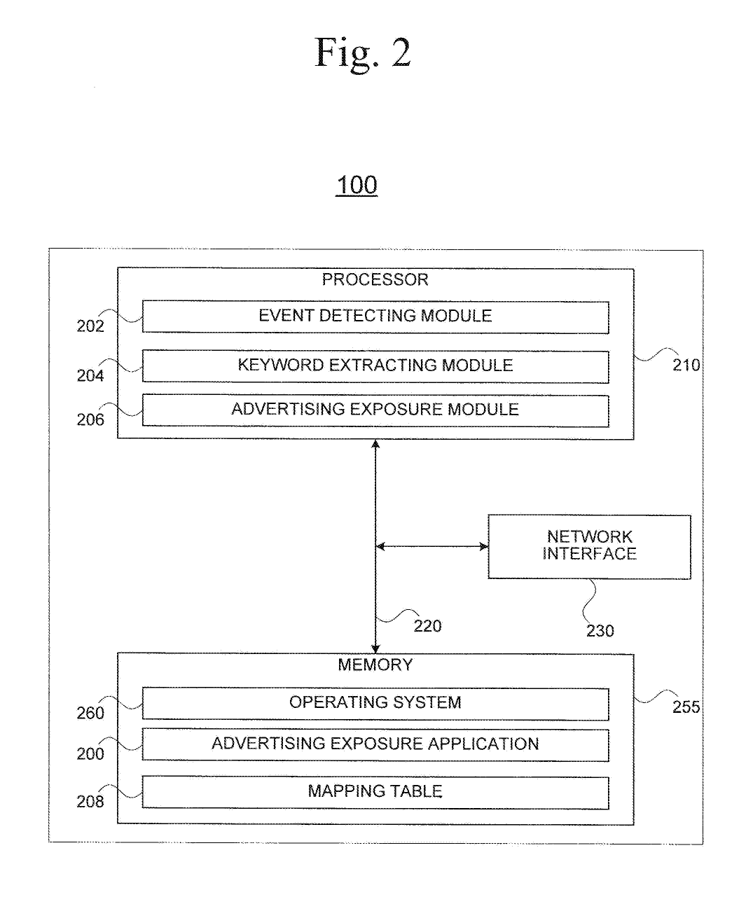

Mobile terminals 100a through 100n may include memory, one or more processors and/or microprocessors, and transceiver. Mobile terminals 100a through 100n may be configured to send/receive data to/from network devices, such as a router, switch, or other like network devices, via a wired or wireless connection. Mobile terminals 100a through 100n may be designed to sequentially and automatically carry out a sequence of arithmetic or logical operations; equipped to record/store digital data on a machine readable medium; and transmit and receive digital data via one or more network devices. In various embodiments, mobile terminals 100a through 100n may include laptops, desktop personal computers (PCs), tablet PCs, mobile cellular phones (e.g., “smartphones”), video cameras, digital photo cameras, MP3 players, and/or any other physical or logical device capable of capturing/recording, storing, and/or transferring data via network 110. Mobile terminals 100a through 100n may include a wireless transceiver configured to operate in accordance with one or more wireless communications standards. A structure and functions of the mobile terminals 100a through 100n will be described in detail later with reference to FIG. 2.

According to various embodiments, advertiser terminals 130a through 130n may be a hardware computing device capable of communicating with a server (e.g., keyword advertising server 120), such that each of the advertiser terminals 130a through 130n are able to receive services from the server. The advertiser terminals 130a through 130n perform functions of applying for keyword advertising by connecting to the keyword advertising server 120 through the network 110 to purchase one or more advertising keywords according to user manipulations, and managing the purchased the one or more advertising keywords.

Advertiser terminals 130a through 130n may include memory, one or more processors and/or microprocessors, and transceiver. Advertiser terminals 130a through 130n may be configured to send/receive data to/from network devices, such as a router, switch, or other like network devices, via a wired or wireless connection. Advertiser terminals 130a through 130n may be designed to sequentially and automatically carry out a sequence of arithmetic or logical operations; equipped to record/store digital data on a machine readable medium; and transmit and receive digital data via one or more network devices. In various embodiments, advertiser terminals 130a through 130n may include laptops, desktop personal computers (PCs), tablet PCs, mobile cellular phones (e.g., “smartphones”), palmtop computers, a personal digital assistants (PDAs), web pads, video cameras, digital photo cameras, MP3 players, and/or any other physical or logical device capable of capturing/recording, storing, and/or transferring data via network 110.

Meanwhile, according to one or more embodiments, a separate advertising keyword for advertising exposure based on event occurrence may be sold. In this case, the advertisers may connect to the keyword advertising server 120 by using the advertiser terminals 130a through 130n, and apply for an advertisement based on event occurrence by purchasing the separate advertising keyword.

According to various embodiments, the network 110 may be wired or wireless network, and may be any one of various communication networks, such as a personal area network (PAN), a local area network (LAN), a metropolitan area network (MAN), a wide area network (WAN), and/or other like network capable of physically or logically connecting computers.

According to various embodiments, keyword advertising server 120 may include a physical computer hardware system that is configured to provide services for client devices (e.g., mobile terminals 100a through 100n, advertiser terminals 130a through 130n, and the like) connected to a network (e.g., network 110). Keyword advertising server 120 may employ one or more connection-oriented protocols such as Session Initiation Protocol (SIP), HTTP, and TCP/IP, and includes network devices that use connectionless protocols such as User Datagram Protocol (UDP) and Internet Packet Exchange (IPX). Keyword advertising server 120 may be configured to establish, manage, and terminate communications sessions, for example between the keyword advertising server 120 and one or more of mobile terminals 100a through 100n and/or advertiser terminals 130a through 130n. Keyword advertising server 120 may also be configured to establish, manage, and terminate communications sessions with two or more client devices. Additionally, the keyword advertising server 120 performs functions of selling an advertising keyword for keyword advertising by providing an advertiser page to the advertiser terminals 130a through 130n, and setting/managing an advertising keyword purchased by a certain advertiser according to setting information received from the advertiser terminals 130a through 130n. Furthermore, in various embodiments, the keyword advertising server 120 may perform functions of receiving event occurrence information from the mobile terminals 100a through 100n and analyzing the received event occurrence information.

According to various embodiments, mobile terminal 100 is connected to database 122. In various embodiments, database 122 may include a database management system (“DBMS”). Database 122 may include a relational database management system (“RDBMS”) database. In other embodiments, alternate DBMS may also be used, such as an object database (“ODBMS”), column-oriented DBMS, correlation database DBMS, and the like. In various embodiments, database 122 may collect and/or store event occurrence information and/or advertising keyword related data for keyword advertising services. Additionally, database 122 may be configured to extract advertising information matching one or more keywords, which are input and transmitted by the mobile terminals 100a through 100n, and provide the extracted advertising information to the mobile terminals 100a through 100n.

Meanwhile, as described above, when the keyword advertising server 120 separately sells an advertising product based on an event occurrence, the keyword advertising server 120 may be configured to provide a separate page for selling the advertising product based on the event occurrence to the advertiser terminals 130a through 130n, and separately store and manage a keyword for advertising exposure based on the event occurrence purchased by an advertiser through the separate page and a matching advertisement in the database 122. In this case, the keyword advertising server 120 is configured to determine whether a keyword received through the network 110 is a keyword for general search advertising or a keyword for advertising exposure based on event occurrence (hereinafter, referred to as an event-keyword), extract an advertisement matching the received keyword from the database 122 according to a result of the determining, and transmit the extracted advertisement through the network 110. Accordingly, even when a same keyword is received, different advertisements may be provided based on whether the received keyword is extracted from a search word or according to event occurrence.

Also, the keyword advertising server 120 may have a structure and functions of a well-known and widely used keyword advertising server, details of which will be omitted herein. Additionally, according to various embodiments, any number of client devices, multiple servers, and/or multiple databases may be present. Additionally, in some embodiments, advertising server 120 and database 122 may be virtual machines, may reside on one or more hardware device, and/or may be provided as part of a cloud computing service.

Structure and Functions of Mobile Terminal According to Embodiment

FIG. 2 is a block diagram of a mobile terminal 100 for performing advertising exposure based on event occurrence, according to an example embodiment. A structure and functions of the mobile terminal 100 according to the current embodiment will now be described with reference to FIG. 2.

As shown, mobile terminal 100 includes central processing 210, bus 220, network interface 230, and memory 255. During operation, memory 255 includes operating system 260, advertising exposure application 200, and mapping table 208. During operation, processor 210 includes event detecting module 202, keyword extracting module 204, and advertising exposure module 206. In some embodiments, mobile terminal 100 may include many more components than those shown in FIG. 2. However, it is not necessary that all of these generally conventional components be shown in order to disclose the illustrative embodiment. For example, mobile terminal 100 may also include a display, a transceiver, and/or other like components.

Memory 255 may be a computer readable storage medium that generally includes a random access memory (RAM), read only memory (ROM), and a permanent mass storage device, such as a disk drive. Memory 255 also stores operating system 260 and program code for advertising exposure application 200 and mapping table 208. These software components may also be loaded from a separate computer readable storage medium into memory 255 using a drive mechanism (not shown). Such separate computer readable storage medium may include a memory card and/or memory stick, disc, DVD/CD-ROM drive, subscriber identification module (SIM) card, and/or other like computer readable storage medium (not shown). In some embodiments, software components may be loaded into memory 255 via network interface 230, rather than via a computer readable storage medium.

Processor 210 may be configured to carry out instructions of a computer program by performing the basic arithmetical, logical, and input/output operations of the system. Instructions may be provided to processor 210 by memory 255 via bus 220, or by network interface 230 via bus 220. Processor 210 is configured to execute program code for event detecting module 202, keyword extracting module 204, and advertising exposure module 206. Such program code may be stored in a storage device (e.g., memory 255).

Bus 220 enables the communication and data transfer between the components of mobile terminal 100. Bus 220 may comprise a high-speed serial bus, parallel bus, storage area network (SAN), and/or other suitable communication technology.

Network interface 230 is a computer hardware component that connects mobile terminal 100 to a computer network (e.g., network 110). Network interface 230 may connect mobile terminal 100 to a computer network via a wired or wireless connection.

The mobile terminal 100 of FIG. 2 according to an example embodiment may be configured by installing the advertising exposure application 200. For convenience of description and understanding, functions according to one or more example embodiments are realized as the advertising exposure application 200 and installed on the mobile terminal 100, and the advertising exposure application 200 is executed by processor 210 in the background of the mobile terminal 100 to detect event occurrence and expose a keyword advertisement according to the event occurrence. However, in various embodiments, instead of the advertising exposure application 200 being realized/installed/executed as a separate application, the advertising exposure application 200 may be installed and executed as a module in another application having a certain and/or desired purpose. Accordingly, example embodiments are not limited by realization/installation/execution of the advertising exposure application 200, and may include hardware, software, and/or a combination of hardware and software performing the same functions. Meanwhile, the advertising exposure application 200 may be provided to the mobile terminal 100 via the keyword advertising server 120 and/or a desired download server (not shown), such as an application store server, and the like.

Also, when the functions are realized as the separate advertising exposure application 200, the advertising exposure application 200 may be configured to detect an event that occurs according to manipulation, by a user, on a currently executed application or to detect an event that occurs when a desired condition is satisfied. The event and/or manipulation may be detected by interworking with at least one application installable/executable on the mobile terminal 100. The at least one application interworking with the advertising exposure application 200 is configured to statically and/or dynamically generate an advertising exposure region on the mobile terminal 100 for exposing an advertisement output by the advertising exposure application 200 according to control of the advertising exposure application 200. Additionally, a corresponding advertisement is exposed on a display of the mobile terminal 100.

According to example embodiments, in order to perform the functions described above, the processor 210 may include an event detecting module 202, a keyword extracting module 204, and an advertising exposure module 206, when the advertising exposure application 200 is executed by the processor 210, as shown in FIG. 2.

The event detecting module 202 performs functions of determining whether a desired event occurs on the mobile terminal 100. If the desired event occurred, the event detecting module 202 generates event occurrence information for identifying the event that has occurred. As described above, examples of the desired event include a user manipulation event that occurred according to manipulation (e.g., selecting, inputting, tapping, using a zoom function, and/or other like gestures) by the user, and a conditional event that occurred when a desired condition (e.g., reaching of a certain region (place), reaching of a certain time, and/or switching to a certain state) is satisfied.

For example, when selecting by the user of a certain component (geographic object, such as a building, a road, a subway station, or a bus station) forming a geographic information screen output by a geographic information providing application is set as a target detecting event, the event detecting unit 202 monitors whether the certain geographic object is selected, and when the certain geographic object is selected, generates and outputs corresponding event occurrence information. Alternatively, when reaching of a desired region (e.g., Gangnam-gu or Gangnam district, Seoul, South Korea) is set as a target detecting event, the event detecting module 202 monitors a location and/or position of the mobile terminal 100. The location and/or position of the mobile terminal 100 may be determined or otherwise obtained by using global positioning system (GPS) information, Wi-Fi information, and/or other like mobile terminal positioning information. When the location and/or position of the mobile terminal 100 is determined to be the certain region, generates and outputs corresponding event occurrence information.

The keyword extracting module 204 is configured to perform a function of extracting a keyword corresponding to the event occurrence information generated by the event detecting module 202. The advertising exposure application 200 according to various embodiments may be configured to extract a keyword corresponding to event occurrence information in any one of various methods as is known.

The advertising exposure application 200 may include mapping table 208 in which a plurality of pieces of event occurrence information and corresponding keywords are mapped. The advertising exposure application 200 is configured to extract a keyword corresponding to generated event occurrence information by referring to the mapping table 208. In various embodiments, the advertising exposure application 200 may not extract a keyword if a corresponding keyword is not in the mapping table 208.

In various embodiments, the advertising exposure application 200 may not include the mapping table 208, but may be configured to extract a keyword by processing generated event occurrence information according to a desired algorithm. For example, when a selection and/or reproduction of a desired object displayed on the mobile terminal 100 is set as a target detecting event, corresponding event occurrence information may include intrinsic identification information of the desired object. In this case, the advertising exposure application 200 may be configured to extract at least a portion of the intrinsic identification information of the desired object included in the event occurrence information according to the desired algorithm, as a keyword corresponding to the event occurrence information.

In various embodiments, the advertising exposure application 200 may include the mapping table 208 in which a plurality of pieces of event occurrence information and corresponding keywords are mapped. Then, when event occurrence information is generated, the advertising exposure application 200 may access the mapping table 208 to extract a keyword, and if a keyword corresponding to the event occurrence information does not exist in the mapping table 208, may extract at least a part of intrinsic identification information of a selected object included in the event occurrence information, as a keyword. When a keyword corresponding to event occurrence information is extracted as described above, the keyword extracting module 204 may output the extracted keyword to the advertising exposure module 206.

The advertising exposure module 206 may be configured to transmit the keyword extracted by the keyword extracting module 204 to the keyword advertising server 120 through the network 110, receive from the advertising server 120 an advertisement matching the event that has occurred, and output the received advertisement on a desired advertising exposure region (e.g., an advertising exposure region of an application interworking with the advertising exposure application 200 and outputting a screen through the display of the mobile terminal 100).

As described above, the keyword extracting module 204 may be configured to use the mapping table 208 to extract a keyword corresponding to event occurrence information, use identification information of a selected object included in event occurrence information without using the mapping table 208, or use the mapping table 208 and use identification information of a selected object. A method of extracting a keyword will now be described in detail according to one or more example embodiments.

1. Extracting Keyword By Only Using Mapping Table 208

The mapping table 208 according to an example embodiment is a table storing information in which a plurality of pieces of event occurrence information associated with events that occur on the mobile terminal 100. Additionally, mapping table 208 may store keywords matching the mapped event occurrence information. In various embodiments, the keyword denotes a keyword matched to an advertisement by the keyword advertising server 120. Setting of an event and a structure of the mapping table 208 will now be described in detail with reference to examples of various applications capable of interworking with the advertising exposure application 200.

1-1) User Manipulation Event and Corresponding Structure of Mapping Table 208

As an example of a user manipulation event, a component forming a screen output on a display of the mobile terminal 100 may be selected by the user according to execution of a certain application installed in the mobile terminal 100. Advertising exposure based on event occurrence will now be described in detail with reference to examples of applications capable of interworking with the advertising exposure application 200.

1-1-1) Interworking with Geographic Information Providing Application

The advertising exposure application 200 may interwork with a geographic information providing application installed on the mobile terminal 100 of the user. Here, as described above, functions of the advertising exposure application 200 may be realized in the geographic information providing application. Geographic information (or alternatively, “geolocation”) may specify a geographic coordinate (e.g., latitude and longitude) and/or a range of geographic coordinates, a Cartesian coordinate (e.g., Universal Transverse Mercator (UTM) coordinate system and/or Universal Polar Stereographic (UPS) coordinate system, and the like) and/or a range of Cartesian coordinates, a GPS coordinate (e.g., 37.523614,127.048937; and the like) and/or a range of GPS coordinates, and/or a street address (e.g., Government Complex Daejeon Building 4, 189, Cheongsa-ro, Seo-gu, Daejeon, 302-701, Republic of Korea). Geographic information may indicate one or more geographic names and/or geographic descriptions (e.g., Han River, Dosan Park, Bukhansan/Bukhan Mountain, Korea Strait, and the like). In various embodiments, the geographic information may specify or otherwise indicate a place and/or venue (e.g., a city and/or county, a neighborhood within a city or municipality, a business, a building, a floor within a building, and/or other like boundary encompassing a two-dimensional or three-dimensional shape). Geographic information may include one or more routes and/or thoroughfare information, such as subway route information, bus route information, navigation information, or any other like map information. Generally, the geographic information may be configured as a geographic information screen by a geographic information application (e.g., a digital interactive map), which may be a single application or a plurality of applications providing different pieces of geographic information, and output to the display of the mobile terminal 100. The advertising exposure application 200 may set selecting by the user on all or some of geographic objects forming the geographic information screen as a monitoring target event, and accordingly, the event detecting module 202 of the advertising exposure application 200 may be configured to monitor whether a certain geographic object set as a monitoring target on the geographic information screen is selected according to manipulation by the user.

Meanwhile, when selecting by the user of a geographic object on the geographic information screen output by the geographic information providing application is set as a monitoring target event, a keyword corresponding to the selected geographic object may include at least a portion of a name, title, address, and/or other like identifying information of the selected geographic object. Additionally, in embodiments that allow users to zoom-in or zoom-out on locations while using an interactive map, a user's zooming-in and/or zooming-out on a desired location may be considered a selection of geographic information. Table 1 below is an example of an event information-keyword mapping table usable with respect to a route information screen of subway line no. 2, in which each subway station of subway line no. 2 exists as a selectable geographic object, in a geographic information providing application providing subway route information.

TABLE 1

| Event Information | Keyword |
|---|---|
| Select geographic object #1 on subway line no. 2 | Seoul National |
| | Univ. of Education |
| Select geographic object #2 on subway line no. 2 | Gangnam |
| . | . |
| . | . |
| . | . |
| Select geographic object #n − 1 on subway | Bangbae |
| line no. 2 | |
| Select geographic object #n on subway line no. 2 | Seocho |

As shown in Table 1, a geographic object corresponding to “Seoul National Univ. of Education station” on subway line no. 2 is set as a geographic object #1, and a corresponding keyword is mapped as “Seoul National Univ. of Education”. Similarly, a geographic object corresponding to “Gangnam station” is set as a geographic object #2, and a corresponding keyword is mapped as “Gangnam”. All or some of stations of subway line no. 2 are set as geographic objects in the same manner, and corresponding keywords are mapped to form the mapping table 208. Meanwhile, when the keyword advertising server 120 is configured such that general keyword advertisements and keyword advertisements based on event occurrence are classified as described above, according to various embodiments, a keyword corresponding to an event may be set to be identified by using a separate identifier. For example, a keyword “Gangnam” in Table 1 may be set as “e: Gangnam” to be identified as an event-keyword. Also, upon receiving the keyword “e: Gangnam”, the keyword advertising server 120 may identify that the received keyword is an event-keyword based on an identifier “e:”, and extract and transmit an advertisement matching the event-keyword “Gangnam” to the mobile terminal 100. It should be noted that in various embodiments, the identifier “e:” may be excluded from the extraction and transmission of the advertisement matching the event-keyword “Gangnam”.

Since the keywords in the mapping table 208 are keywords used for keyword advertising performed in the keyword advertising server 120, the keywords may be generated by the keyword advertising server 120 and updated by being transmitted from the keyword advertising server 120 to the mobile terminal 100 in real-time and/or periodically.

When the user is looking at the route information screen of subway line no. 2 by activating the geographic information providing application on the mobile terminal 100 while the mapping table 208 is set as Table 1, the event detecting module 202 of the advertising exposure application 200 may determine whether a geographic object set as a monitoring target on the route information screen is selected, and when an event occurs, for example, when the geographic object #2 is selected, generates and outputs event occurrence information about selecting of the geographic object #2 to the keyword extracting module 204.

The keyword extracting module 204 receives the event occurrence information (selecting of the geographic object #2) generated/output by the event detecting module 202, and extracts a keyword matching the input event occurrence information by referring to the mapping table 208, such as Table 1. In the above example, since the selecting of the geographic object #2 is the event occurrence information, the keyword extracting module 204 extracts the keyword “Gangnam”, and outputs the keyword to the advertising exposure module 206.

The advertising exposure module 206 transmits the keyword (Gangnam) input from the keyword extracting module 204 to the keyword advertising server 120 through the network 110, receives advertising information matching the keyword (i.e., the event that has occurred, from the keyword advertising server 120), and interworks with the geographic information providing application to output an advertisement through a desired advertising exposure region on the route information screen. Here, as described above, a desired advertising exposure region may exist on the route information screen, or if an advertisement is to be output (i.e., when advertising information matching an event that has occurred is received), an advertising exposure region may be dynamically generated so that the advertisement is output. When an advertising exposure region is dynamically generated, any one of various methods may be used. For example, a less important region (for example, a blank region) on the geographic information screen may be detected and the advertising exposure region may be generated on the detected less important region for user convenience. Thus, in such embodiments, the advertising exposure region may be a dynamic advertising exposure region.

1-1-2) Interworking with Content Providing Application

The advertising exposure application 200 may interwork with a content providing application installed in the mobile terminal 100 of the user. Here, as described above, the functions of the advertising exposure application 200 may be realized in the content providing application. Content may include any one of text, audio, and/or video data, as received from, or otherwise provided by a content providing server (not shown). Content may also denote various types of information and details thereof provided by a content providing server (not shown) to the mobile terminal 100 through the network 110, such as news information, movie information, performance information, meteorological conditions information, travel information, and/or other types of information. Generally, when a content providing application is driven on the mobile terminal 100, the content providing application outputs a content selecting screen provided by the content providing server through the display of the mobile terminal 100 by connecting to the content providing server through the network 110. The content providing application may receive one or more user manipulations via the content selecting screen. The content providing application requests the content providing server to provide a desired content selected according to one or more manipulations by the user, receives the desired content from the content providing server, and outputs the received content through the display, so as to provide the content desired by the user. Additionally, in embodiments that allow users to zoom-in or zoom-out on desired portions of a displayed content while using a content providing application, a user's zooming-in and/or zooming-out on a desired portion of the content may be considered a content selection.

In embodiments where the content providing server provides a relatively large number of contents, the provided contents may be categorized according to a desired standard, and a list of available contents may be provided and/or organized according to categories. Also, the categories may be further divided into sub-categories. Additionally, the content providing service may be a portal service that provides many and various types of content, and a content selecting screen using a desired category is generally provided. For example, when news information content is provided, news information may be categorized into “Politics”, “Society”, “Economics”, “Life/Culture”, “World”, “IT/Science”, “Entertainment”, and “Sports”, wherein “Economics” may be sub-categorized into “Stocks” and “Real Estate”, and “Sports” may be sub-categorized into “Domestic Baseball”, “International Baseball”, “Domestic Soccer”, and “International Soccer”. Users may receive desired content by selecting a title of the desired content, which indicates the corresponding desired content from a list, from the content selecting screen output on the mobile terminal 100. In this case, the content selecting screen provided by the content providing server may include category selecting objects for selecting a certain category, and content selecting objects for selecting a certain category. In a content selecting object, since a content list provided by the content providing server dynamically changes, it may not be convenient to pre-prepare and/or pre-arrange a mapping table. On the other hand, a category selecting object displayed on the content selecting screen may not change unless a category classifying standard is changed, and thus a corresponding mapping table may be pre-prepared and/or pre-arranged. Thus, selecting of a category selecting object on the content selecting screen is set as an event, and in various embodiments, at least a portion of a title of a category may be mapped as a keyword matching the selecting of the category selecting object, so as to provide a user-customized advertisement. Table 2 below is an example of event information-keyword mapping table usable with respect to the selecting of a category selecting object set as an event, wherein each category selecting button displayed on the content selecting screen exists as a selectable category selecting object, in a content providing application for providing news information contents.

TABLE 2

| Event Information | Keyword |
|---|---|
| Select category selecting object #1 on content selecting | Politics |
| screen | |
| Select category selecting object #2 on content selecting | Economics |
| screen | |
| Select category selecting object #2-1 on content selecting | Real Estate |
| screen | |
| Select category selecting object #2-2 on content selecting | Stocks |
| screen | |
| . | . |
| . | . |
| . | . |
| Select category selecting object #n − 1 on content | IT/Science |
| selecting screen | |
| Select category selecting object #n on content | Entertainment |
| selecting screen | |

As shown in Table 2, when “Economics” is sub-categorized into “Real Estate” and “Stocks”, corresponding event information-keyword mapping may be added to a mapping table. For example, a category selecting button of “Real Estate” below “Economics” may be set to a category selecting object #2-1 and a matching keyword may be set to “Real Estate”, and a category selection button of “Stocks” below “Economics” may be set to a category selecting object #2-2 and a matching keyword may be set to “Stocks”.

When the user is looking at the content selecting screen by driving the content providing application on the mobile terminal 100 while the mapping table 208 as shown in Table 2 is set, the event detecting module 202 of the advertising exposure application 200 determines whether a category selecting object set as a monitoring object on the content selecting screen is selected, and when an event occurs, for example, when the category selecting object #2-2 is selected, generates event occurrence information about the selecting of the category selecting object #2-2, and outputs the generated event occurrence information to the keyword extracting module 204.

The keyword extracting module 204 receives the event occurrence information about the selecting of the category selecting object #2-2 generated/output by the event detecting module 202, and extracts a keyword matching the input event occurrence information by referring to the mapping table 208 like Table 2. Since the selecting of the category selecting object #2-2 is the event occurrence information in the above example, the keyword extracting module 204 extracts the keyword “Stocks” and outputs the keyword “Stocks” to the advertising exposure module 206.

The advertising exposure module 206 transmits the keyword (Stocks) input from the keyword extracting module 204 to the keyword advertising server 120 through the network 110, receives advertising information matching the keyword, i.e., an event that has occurred, from the keyword advertising server 120, and outputs a received advertisement through a desired advertising exposure region by interworking with the content providing application.

Meanwhile, an event occurrence detecting algorithm of the geographic information providing application and/or an event occurrence detecting algorithm of the content providing application described above may be applied to a travel information content providing application from among content providing applications. For example, when the travel information content providing application outputs travel-related geographic information and a geographic object on a geographic information screen is selected, it is determined that an event has occurred. Also, when travel information is categorized and provided, and a category selecting object is selected, it may be determined that an event has occurred.

On the other hand, an event occurrence detecting algorithm of the content providing application described above and/or an event occurrence detecting algorithm of a content reproducing application described below may be applied to a movie information content providing application from among content providing applications. For example, when movie information is categorized and listed, and a category selecting object is selected, it may be determined that an event has occurred, and/or when certain movie information listed on a screen is selected, it may be determined that an event has occurred. When the certain movie information is selected according to manipulation by the user, the mobile terminal 100 may transmit the selected movie information (e.g., at least a part of a movie title) to the keyword advertising server 120, and the keyword advertising server 120 may transmit an advertisement matching the received movie information or an advertisement of a movie-related application (e.g., CJ Golden Village (CGV) theatres application, and the like) to the mobile terminal 100, or transmit a link of another application or webpage for supplementing a content of the movie information content providing application, as an advertisement.

1-1-3) Interworking with Content Reproducing Application

The advertising exposure application 200 may interwork with a content reproducing application installed on the mobile terminal 100. Here, as described above, functions of the advertising exposure application 200 may be configured to be realized in the content reproducing application. The content reproducing application is an application for reproducing content, such as information content as described above, and/or multimedia content, such as an image, a moving image, and/or music. The content reproducing application may reproduce multimedia content stored on the mobile terminal 100 and/or multimedia content transmitted from a content providing server (not shown) by displaying or otherwise executing the content stored on the mobile terminal 100. Examples of the content reproducing application include an art work appreciating application, a video viewing application, a music player application, and an electronic book reading application.

A mapping table for the content reproducing application may be dynamically generated. For example, while forming and outputting a reproduction content selecting screen, a mapping table may be generated by dynamically mapping content selecting objects forming the reproduction content selecting screen and at least a portion of names and/or titles of corresponding content, by referring to metadata of content stored in a designated path or metadata of content transmitted from the content providing server. Also, when the content reproducing application reproduces content in the designated path, the mapping table may be statically generated and provided from a server as described above.

Table 3 below is an example of an event information-keyword mapping table used for a content reproducing application for reproducing electronic book content, wherein content selecting buttons on an electronic book content selecting screen exist as content selecting objects selectable by a user, and selecting of a content selecting object is set as an event. A keyword corresponding to a content selecting object may include all or part of a content title, or may include a title (all or part of) of a content author.

TABLE 3

| Event Information | Keyword |
|---|---|
| Select content selecting object #1 on reproduction content | Alchemist |
| selecting screen | |
| Select content selecting object #2 on reproduction content | Justice |
| selecting screen | |
| . | . |
| . | . |
| . | . |
| Select content selecting object #n − 1 on reproduction | Harry Porter |
| content selecting screen | |
| Select content selecting object #n on reproduction content | Lord of |
| selecting screen | the Flies |

When the mapping table 208 like Table 3 is set and the user is looking at the reproduction content selecting screen by driving the content reproducing application on the mobile terminal 100, the event detecting module 202 of the advertising exposure application 200 determines whether a content selecting object set as a monitoring target on the reproduction content selecting screen is selected, and when an event occurs, for example, when a content selecting object #2 is selected, generates event occurrence information indicating that the content selecting object #2 is selected, and outputs the event occurrence information to the keyword extracting module 204.

The keyword extracting module 204 receives the event occurrence information (the selecting of the content selecting object #2) generated/output by the event detecting module 202, and extracts a keyword matching the received event occurrence information by referring to the mapping table 208 (e.g., Table 3). In the above example, since the event occurrence information is associated with the selecting of the content selecting object #2, the keyword extracting module 204 extracts a keyword “Justice”, and outputs the keyword to the advertising exposure module 206.

The advertising exposure module 206 transmits the keyword (Justice) received from the keyword extracting module 204 to the keyword advertising server 120 through the network 110, receives advertising information matching the keyword (i.e., an event that has occurred), from the keyword advertising server 120, and outputs an advertisement through a desired advertising exposure region by interworking with the content reproducing application.

Hereinabove, several types of applications installable and executable on the mobile terminal 100 have been described as examples, but example embodiments are not limited thereto and may be usable by interworking with various applications (or certain functions in an application).

1-2) Conditional Event and Structure of Mapping Table

As described above, a conditional event is an event that automatically occurs when a desired condition is satisfied. Examples of the conditional event include a conditional event that occurs when the mobile terminal 100 enters a desired place and/or is determined to be in a desired location. A conditional event may occur when desired content is reproduced and/or when a desired application is executed on the mobile terminal 100. A conditional event may occur when a desired time (e.g., 3:00 PM) is reached. Additionally, a conditional event may include a combination of desired conditions are satisfied, such as entering a desired place at a desired time, and the like.

In the conditional event that occurs when the mobile terminal 100 enters a desired certain place, a matching keyword may include at least a portion of a title and/or address of the desired place. In the conditional event that occurs when reproducing certain content or executing a certain application on the mobile terminal 100 satisfies a desired condition, a matching keyword may include at least a portion of a title of the certain content or certain application. Meanwhile, when a content reproduced in the content reproducing application described above is automatically changed (e.g., when a slide show function of images is selected or music contents based on a reproduction list are continuously reproduced), a keyword corresponding to a currently automatically reproduced content may be transmitted to the keyword advertising server 120, and keyword advertising corresponding to the currently automatically reproduced content may be received and output from the keyword advertising server 120. Also, in the conditional event that occurs when a certain time is reached, the certain time may be mapped as a keyword.

2. Extracting Keyword based on Identification Information of Selected Object

The advertising exposure application 200 may not include the mapping table 208 described above, and may extract a keyword by processing generated event occurrence information according to a desired algorithm. An example embodiment of extracting a keyword from event occurrence information and exposing a user to an advertisement based on the keyword will now be described through examples of applications interworking with the advertising exposure application 200. Embodiments that do not include the mapping table 208 may be the same or similar as those using the mapping table 208, except that the embodiments that do not include the mapping table 208 do include a method of extracting a keyword. Thus, a method of extracting a keyword, according to various embodiments, will now be described, and overlapping descriptions will be omitted.

2-1) User Manipulation Event

In a user manipulation event, the advertising exposure application 200 may be configured to extract a keyword based on identification information (a name, a file name, or a title) of an object selected or content reproduced according to manipulation by a user.

2-1-1) Interworking with Geographic Information Providing Application

The event detecting module 202 of the advertising exposure application 200 is configured to monitor whether a certain geographic object set as a monitoring target on a geographic information screen is selected according to manipulation by a user.

When the user is looking at a route information screen of subway line no. 2 by executing a geographic information providing application on the mobile terminal 100, the event detecting module 202 of the advertising exposure application 200 determines whether a geographic object set as a monitoring target on the route information screen is selected, and when an event occurs, for example, when a geographic object corresponding to “Yeoksam station” is selected, generates and outputs event occurrence information indicating that the geographic object “Yeoksam station” is selected to the keyword extracting module 204. Here, the generated event occurrence information may include identification information of the selected geographic object, for example, “Yeoksam station” as a title of the selected geographic object. In other words, in this case, the event occurrence information includes details that the geographic object “Yeoksam station” is selected from the route information screen of subway line no. 2.

The keyword extracting module 204 receives the generated/output event occurrence information from the event detecting module 204 and extracts a keyword by analyzing the event occurrence information. According to an embodiment, the keyword extracting module 204 may extract a keyword based on the identification information of the selected geographic object included in the event occurrence information. In the above example, since the selected geographic object includes the identification information “Yeoksam station”, the keyword extracting unit 204 may extract a keyword “Yeoksam station” and/or “Yeoksam”. According to an embodiment, the keyword extracting unit 204 may analyze a morpheme, syllable, and/or other like portion of the identification information of the selected geographic object, and extract a plurality of keywords based on a result of the analyzing. When the plurality of keywords are extracted, some or all of the extracted keywords may be output.

The advertising exposure module 206 transmits a keyword (Yeoksam or Yeoksam station) input from the keyword extracting module 204 to the keyword advertising server 120 through the network 110, receives advertising information matching the keyword, i.e., an event that has occurred, from the keyword advertising server 120, and outputs an advertisement on a desired advertising exposure region on the route information screen of subway line no. 2 by interworking with the geographic information providing application.

2-1-2) Interworking with Content Providing Application

The advertising exposure application 200 may interwork with a content providing application installed on the mobile terminal 100 of a user. When the user is looking at a news information content selecting screen by executing the content providing application on the mobile terminal 100, the event detecting module 202 of the advertising exposure application 200 determines whether a content category selecting object set as a monitoring target on the news information content selecting screen is selected. Then, when an event occurs, for example, when a category selecting object including identification information “Real Estate” is selected, event occurrence information about the selecting of the category selecting object including the identification information “Real Estate” is generated and output to the keyword extracting unit 204. The keyword extracting unit 204 receives the event occurrence information generated/output by the event detecting module 202, and extracts a keyword “Real Estate” by processing the event occurrence information.

In other content providing applications, such as a travel information content providing application and a movie information content providing application, when the user selects a certain object (category selecting object or content object) displayed on a content selecting screen, identification information (or some of identification information) of the selected certain object may be extracted as a keyword, like the news information content providing application.

2-1-3) Interworking with Content Reproducing Application

When the user is looking at a reproduction content selecting screen by executing a content reproducing application on the mobile terminal 100, the event detecting module 202 of the advertising exposure application 200 determines whether a content selecting object set as a monitoring target on the reproduction content selecting screen is selected, and when an event occurs, for example, when a content including identification information “The Lord of the Rings-1” is selected as a reproduction target content, the event detecting module 202 generates and outputs event occurrence information including at least a part of the identification information “The Lord of the Rings-1” to the keyword extracting module 204. The identification information may be a file name of the reproduction target content and/or meta information (or a portion of meta information) of the reproduction target content. The keyword extracting module 204 extracts a keyword by processing the identification information included in the event occurrence information.

As described above, the advertising exposure application 200 may extract a keyword without having to use the mapping table 208, by extracting and processing identification information of an object via a desired algorithm, when the object is selected according to manipulation by the user from among objects forming a currently output screen on the mobile terminal 100.

2-2) Conditional Event

Meanwhile, when a conditional event described above is processed, the keyword extracting module 204 of the advertising exposure application 200 may determine whether a conditional event set as a monitoring target occurred, and when the conditional event occurred since a desired condition is satisfied, the advertising exposure application 200 may extract the desired condition (or a part of the desired condition) as a keyword. For example, in a conditional event that occurs when the mobile terminal 100 enters a certain place and/or location, identification information (e.g., a name, address, or other like identifying information) of the certain place may be extracted as a keyword. In a conditional event that occurs when a certain content is reproduced or a certain application is executed, identification information of the certain content or certain application may be extracted as a keyword, and in a conditional event that occurs when a certain time (for example, 3:00 PM) is reached, the certain time may be extracted as a keyword.

Also, when content reproduced in the content reproducing application described above is automatically changed (e.g., when a slide show function of images is selected or music contents based on a reproduction list are continuously reproduced), a keyword corresponding to currently automatically reproduced content may be transmitted to the keyword advertising server 120, and keyword advertising corresponding to the currently automatically reproduced content may be received and output from the keyword advertising server 120.

3. Extracting Keyword by Firstly using Mapping Table 208 and Secondly using Identification Information of Selected Object

The advertising exposure application 200 may include the mapping table 208, and the event detecting module 202 generates event occurrence information including identification information of an object selected or reproduced according to manipulation by the user with respect to a user manipulation event, or event occurrence information including a satisfied condition with respect to a conditional event. The keyword extracting module 204 extracts a keyword corresponding to an event that has occurred by referring to the mapping table 208, and if the keyword does not exist in the mapping table 208, extracts a keyword based on the identification information or the satisfied condition included in the event occurrence information. For example, in the news information content providing application described above, the mapping table 208 having category selecting objects forming a content selecting screen may exist. In this case, when the user selects a desired category selecting object on the content selecting screen, the keyword extracting module 204 extracts a keyword by referring to the mapping table 208. Meanwhile, when the user selects a desired content selecting object to receive certain content on the content selecting screen, the keyword extracting module 204 attempts to extract a corresponding keyword by referring to the event occurrence information and the mapping table 208. However, if the corresponding keyword does not exist in the mapping table 208, the keyword extracting module 204 may extract a keyword based on identification information of the certain content selecting object included in the event occurrence information. According to such embodiments, keyword advertising may be efficiently performed in a content providing application, such as a news information content providing application or a movie information providing application, or a content reproducing application, such as an art work appreciating application, a video playing application, a music playing application, and/or an electronic book reading application, wherein a category itself may change but the provided and/or displayed content is dynamically changed.

Meanwhile, according to various embodiments, the keyword extracting module 204 may be configured to selectively perform keyword extraction based on a mapping table and extracting of a keyword based on identification information. For example, the keyword extracting module 204 may be configured to perform any one of the firstly extracting of a keyword and the secondly extracting of a keyword according to a keyword extracting setting. In this case, the keyword extracting setting may be set according to setting information transmitted from the keyword advertising server 120 through the network 110, or according to manipulation by the user. Alternatively, in various embodiments, the keyword extracting module 204 may be configured to perform the keyword extraction from a mapping table and only perform the keyword extraction based on the identification information a desired condition is satisfied. As another alternative, in some embodiments, the keyword extracting module 204 may be configured to perform the keyword extraction based on the identification information and only perform the extracting of a keyword based on the mapping table when a desired condition is satisfied. In other words, the keyword extracting module 204 may be configured to perform the keyword extraction according to a desired condition, wherein the desired condition may be variously set and is not limited to one or more embodiments above.

Structure and Functions of Advertising Exposure System based on Event Occurrence according to Another Embodiment

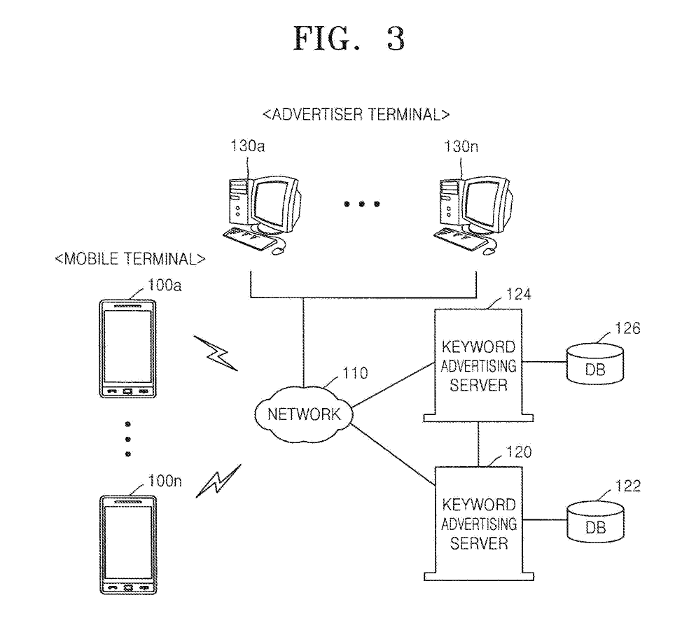

FIG. 3 is a block diagram of an advertising exposure system based on event occurrence, according to an example embodiment. The system according to the previously described embodiments as shown in FIGS. 1 and 2 and the system according to the current embodiment shown in FIG. 3 perform similar functions overall. Thus, each element as shown in FIG. 3 may include the same or similar features and internal structure of the elements shown in FIGS. 1 and 2. However, unlike the previously described embodiments, a keyword may be extracted by a keyword extracting server 124 on the network 110 instead of the mobile terminal 110. Accordingly, overlapping descriptions about structures and functions are not repeated, and the example embodiment described below will be described based on the differences therebetween.

Since the keyword extracting server 124 extracts a keyword, an advertising exposure application of the mobile terminal 100 according to example embodiments may not use and/or include the keyword extracting module 204 and the mapping table 208, unlike the advertising exposure application of the previous described embodiments.

The keyword extracting server 124 according to the current embodiment receives event occurrence information transmitted from the mobile terminal 100, and extracts a keyword corresponding to an event that has occurred based on the event occurrence information. Like the embodiments described above, a keyword may be extracted based on any one of the following three methods. First, the keyword extracting server 124 may be configured to extract a keyword matching an event that has occurred by referring to a mapping table stored in the database 122. Second, the keyword extracting server 124 may be configured to extract a keyword by processing identification information and/or condition information of a selected/reproduced object included in event occurrence information transmitted from the mobile terminal 100. Thus, in various embodiments, the keyword extracting server 124 may not require the use of a mapping table. Third, the keyword extracting server 124 may be configured to extract a keyword by referring to a mapping table and extract a keyword by processing identification information and/or condition information of a selected/reproduced object included in event occurrence information. When a keyword is extracted according to any one of the three methods, the keyword extracting server 124 transmits the extracted keyword to the keyword advertising server 120.

The keyword advertising server 120 receives the identification information of the mobile terminal 100 and the keyword from the keyword extracting server 124, extracts an advertisement matching the received keyword from the database 122, and transmits the advertisement to the mobile terminal 100 based on the identification information of the mobile terminal 100.

The keyword extracting server 124 and the keyword advertising server 120 may be physically and/or logically separated from each other or physically and/or logically integrated with each other.

Operations of Advertising Exposure System based on Event Occurrence according to Embodiment

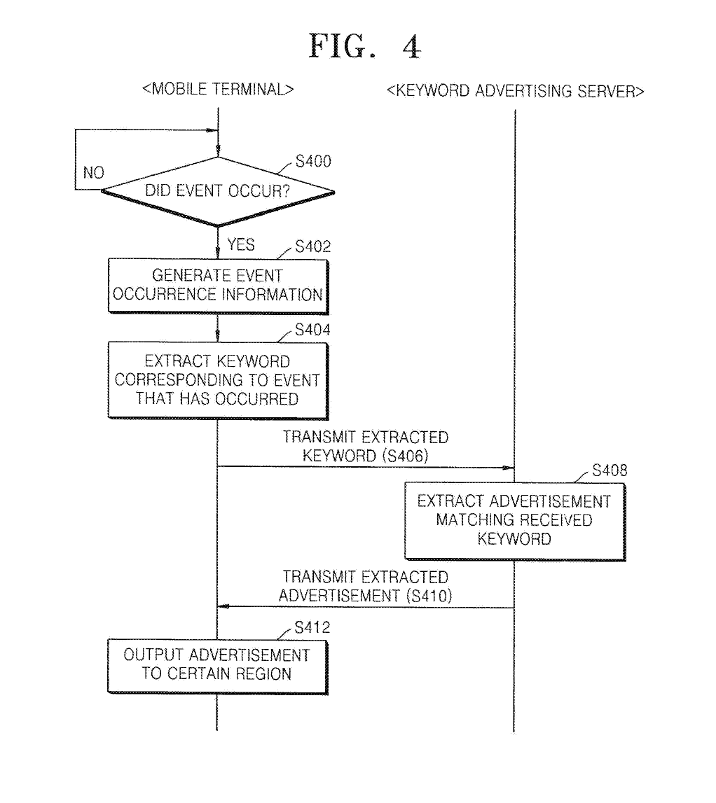

FIG. 4 is a flowchart illustrating operations of an advertising exposure system based on event occurrence, according to an example embodiment. The operations of the advertising exposure system based on event occurrence, according to the current embodiment will now be described with reference to FIG. 4.

As shown in operation S400, the mobile terminal 100 determines whether a desired event (e.g., a user manipulation event and/or conditional event) has occurred on the mobile terminal 100. As described above, when an advertising exposure function is realized as the advertising exposure application 200, event occurrence may be continuously determined, and when the advertising exposure function is realized as a partial function of a certain application, event occurrence may be determined only when the certain application is executed. Thus, as shown in FIG. 4, if the mobile terminal 100 does not determine that a desired event has occurred, then the mobile terminal 100 proceeds back to operation S400 to determine whether the desired event has occurred.

When it is determined that the event occurred, the mobile terminal proceeds to operation S402, where the mobile terminal 100 generates event occurrence information for identifying the event that has occurred. Once the event occurrence information is generated, the mobile terminal proceeds to operation S404 to extract a keyword matching the event that has occurred. As described above, the mobile terminal 100 may i) extract a keyword matching the event that has occurred by referring to the mapping table 208 stored in the mobile terminal 100, ii) extract a keyword based on identification information or condition information of a selected/reproduced object included in the event occurrence information, and/or iii) extract a keyword by referring to the mapping table 208 and then extract a keyword based on identification information or condition information of a selected/reproduced object.

When the keyword matching the event that has occurred is extracted, the mobile terminal 100 proceeds to operation S406 to transmit the extracted keyword to the keyword advertising server 120 through the network 110. Once the keyword advertising server 120 receives the keyword from the mobile terminal 100, as shown in operation S408, the keyword advertising server 120 extracts advertising information matching the keyword from the database 122. In embodiments where the keyword includes a plurality of sub-keywords, the keyword advertising server 120 may classify the keyword into the plurality of sub-keywords, each of which may include a priority and/or importance level. In such embodiments, the keyword advertising server 120 may extract suitable advertising information according to the priority and/or importance level of one or more of the sub-keywords.

As shown in operation S410, when the advertising information is extracted, the keyword advertising server 120 transmits the extracted advertising information to the mobile terminal 100 through the network 110. As shown in operation S412, upon receiving the advertising information, the mobile terminal 100 outputs an advertisement through a desired advertising exposure region.

Operations of Advertising Exposure System based on Event Occurrence according to Another Embodiment

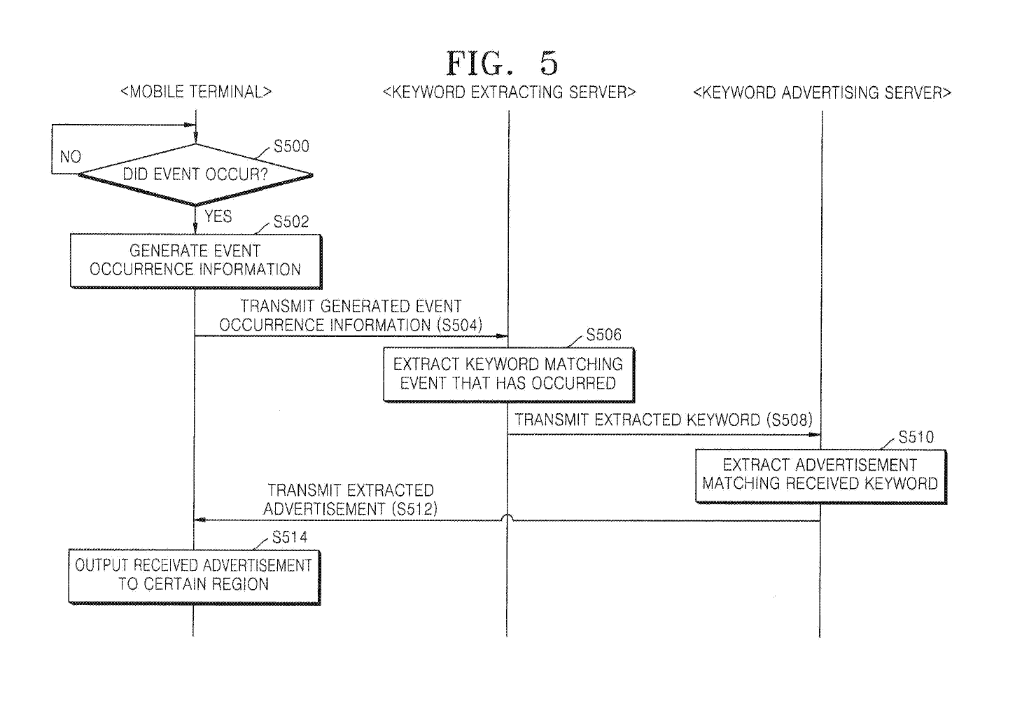

FIG. 5 is a flowchart illustrating operations of an advertising exposure system based on event occurrence, according to an example embodiment. The operations of the advertising exposure system based on event occurrence, according to example embodiments will now be described with reference to FIG. 5. The example embodiment as shown in FIG. 5 is different from the previously described embodiment because a keyword extracting function is performed by the keyword extracting server 124 as described above with reference to FIG. 3.

As shown in operation S500, the mobile terminal 100 determines whether a desired event (user manipulation event and/or conditional event) occurred on the mobile terminal 100. As shown in FIG. 5, if the mobile terminal 100 does not determine that the desired event has occurred, then the mobile terminal 100 proceeds back to operation S500 to determine whether the desired event has occurred. As shown in operation S502, when it is determined that the desired event occurred, the mobile terminal 100 generates event occurrence information for identifying the event that has occurred. As shown in operation S504, the mobile terminal 100 transmits the event occurrence information to the keyword extracting server 124 through the network 110.

As shown in operation S506, the keyword extracting server 124 receives the event occurrence information and extracts a keyword corresponding to the event that has occurred based on the received event occurrence information. Here, as described above, the keyword extracting server 124 may i) extract a keyword matching the event that has occurred by referring to the mapping table 208 stored in the keyword extracting server 124, ii) extract a keyword based on identification information or condition information of a selected/reproduced object included in the received event occurrence information, or iii) extract a keyword by referring to the mapping table 208 and extract a keyword based on identification information or condition information of a selected/reproduced object.

As shown in operation S508, when the keyword matching the occurred keyword is extracted, the keyword extracting server 124 transmits the extracted keyword to the keyword advertising server 120. As shown in operation S510, the keyword advertising server 120 extracts advertising information matching the received keyword. As shown in operation S512, the keyword advertising server 120 transmits the advertising information to the mobile terminal 100 through the network 110.

As shown in operation S514, the mobile terminal 110 receives an advertisement of the advertising information from the keyword advertising server 120 and outputs the advertisement through a desired advertising exposure region.

As described above, according to the one or more of the example embodiments, an event that occurs on a mobile terminal may be detected and a target advertisement particularly related to the detected event may be provided. Also, an advertising exposure effect based on event occurrence, which may interwork with a widely operated keyword advertising system, may be obtained. In addition, a location-based target advertisement may be provided based on mobility of a mobile terminal.

The example embodiments may be written as program commands executable by any computer hardware device that includes a processor, and where the program commands are recorded in a computer-readable recording medium. The computer-readable recording medium may include a program command, a data file, and a data structure solely or in combination. The program commands recorded in the computer-readable recording medium may be specifically designed and configured for the present invention, or may be well known to and usable by one of ordinary skill in the art of computer software. Examples of the computer-readable recording medium include magnetic media (e.g., hard disks, floppy disks, and magnetic tapes), optical media (e.g., CD-ROMs and DVDs), magneto-optical media (e.g., floptical disks), and hardware devices specifically configured to store and execute program commands (e.g., ROMs, RAMs, and flash memories). Examples of program commands include not only machine language codes prepared by a compiler, but also high-level language codes executable by a computer by using an interpreter. The hardware device may be configured to operate as at least one software module to perform operations of the methods, or vice versa.

It should be understood that the exemplary embodiments described herein should be considered in a descriptive sense only and not for purposes of limitation. Descriptions of features or aspects within each embodiment should typically be considered as available for other similar features or aspects in other embodiments.

While example embodiments have been described with reference to the figures, it will be understood by those of ordinary skill in the art that various changes in form and details may be made therein without departing from the spirit and scope as defined by the following claims.

What is claimed is:

1. A method of providing an advertisement based on event occurrence on a mobile terminal, the method being performed by a keyword advertising server, the method comprising:
determining, by the keyword advertising server, that a desired event has occurred on the mobile terminal;
obtaining, by the keyword advertising server, event occurrence information, the event occurrence information being associated with the desired event;
extracting a keyword based on the obtained event occurrence information; and
providing, by the keyword advertising server, an advertisement based on the extracted keyword.

2. The method of claim 1, wherein the keyword is extracted from the mobile terminal, and the method further comprises:
receiving the extracted keyword from the mobile terminal after the extracting, and the provided advertisement corresponds to the extracted keyword from the mobile terminal.

3. The method of claim 1, wherein the keyword is extracted from the keyword advertising server, and wherein
the mobile terminal transmits the generated event occurrence information to the keyword advertising server after generating the event occurrence information, and
the provided advertisement corresponds to the extracted keyword from the keyword advertising server.

4. The method of claim 1, wherein the extracting of the keyword comprises:
accessing a mapping table, the mapping table mapping a plurality of portions of event occurrence information to a corresponding one of a plurality of keywords; and
determining at least one keyword that corresponds to a portion of the generated event occurrence information.

5. The method of claim 1, wherein the generated event occurrence information includes an object selected according to a user manipulation of the mobile terminal, and the extracting the keyword comprises:
extracting a keyword based on the selected object.

6. The method of claim 1, wherein the generated event occurrence information includes an object selected according to a user manipulation of the mobile terminal, and the extracting the keyword comprises:
extracting a keyword by accessing a mapping table, the mapping table mapping a plurality of portions of event occurrence information to a corresponding one of a plurality of keywords; and
extracting the keyword based on the selected object.

7. The method of claim 6, wherein the extracting the keyword based on the selected object occurs if a keyword is not extracted by accessing the mapping table.

8. The method of claim 1, wherein the desired event is a user manipulation event that has occurred on the mobile terminal.

9. The method of claim 8, wherein the user manipulation event includes a user selection as defined by an executed application on the mobile terminal.

10. The method of claim 9, wherein the executed application is a geographic information providing application having selectable geographic objects on a geographic information screen, and the extracted keyword corresponds to a portion of a selected geographic object.

11. The method of claim 10, wherein the geographic information providing application provides thoroughfare information and at least one selectable geographic object includes at least one portion of the thoroughfare information.

12. The method of claim 10, wherein the executed application is a content providing application having selectable content category objects on a content selecting screen, and the extracted keyword corresponds to a portion of a selected content category object.

13. The method of claim 12, wherein the content providing application provides at least one content from among news information content, movie information content, travel information content, and music information content.

14. The method of claim 9, wherein the executed application is a content reproducing application having selectable content objects on a content selecting screen, and the extracted keyword corresponds to a portion of a selected content object.

15. The method of claim 1, wherein the desired event is a conditional event that occurs when a desired condition is satisfied.

16. The method of claim 15, wherein the conditional event is based on a desired position of the mobile terminal, and the determining comprises:
determining that the mobile terminal is in a vicinity of the desired position.

17. The method of claim 16, wherein the desired position is associated with at least one of a region and a venue.

18. The method of claim 16, wherein the extracted keyword corresponds to a portion of a description of the desired position.

19. The method of claim 15, wherein the conditional event is based on desired content being executed on the mobile terminal, and the determining comprises:
determining that the desired content is executed on the mobile terminal.

20. The method of claim 19, wherein the desired content corresponds to a category, and the extracted keyword corresponds to a portion of a description of the category.

21. The method of claim 15, wherein the conditional event is based on a desired time, and the determining comprises:
determining that the mobile terminal has reached the desired time.

22. A non-transitory computer-readable recording medium having recorded thereon a program, that when executed by a processor, performs a function of:
determining that a desired event has occurred on the mobile terminal;
obtaining event occurrence information, the event occurrence information being associated with the desired event;
extracting a keyword based on the generated event occurrence information; and
providing an advertisement based on the extracted keyword.

23. A system for providing an advertisement to a mobile terminal based on event occurrence at the mobile terminal, the system comprising:
a mobile terminal including,
an event detecting module configured to, determine that a desired event has occurred on the mobile terminal, and
generate event occurrence information, the event occurrence information being associated with the desired event;
a keyword extracting module configured to extract a keyword based on the generated event occurrence information; and
an advertising exposure module configured to obtain, from a server, an advertisement based on the extracted keyword.

24. The system of claim 23, wherein in the obtaining, the advertising exposure module is further configured to:
transmit the keyword extracted by the keyword extracting module to a keyword advertising server, and
receive an advertisement corresponding to the extracted keyword.

25. The system of claim 23, wherein the keyword advertising server extracts a keyword corresponding to the desired event based on the event occurrence information.

26. The system of claim 23, wherein the keyword extracting module is further configured to:
access a mapping table, the mapping table mapping a plurality of portions of event occurrence information to a corresponding one of a plurality of keywords; and
determine at least one keyword that corresponds to a portion of the generated event occurrence information.

27. The system of claim 23, wherein the generated event occurrence information includes an object selected according to a user manipulation of the mobile terminal, and the keyword extracting module is further configured to:
extract the keyword based on the selected object.

28. The system of claim 23, wherein the desired event is a user manipulation event that has occurred on the mobile terminal.

29. The system of claim 28, wherein the user manipulation event includes a user selection as defined by an executed application on the mobile terminal.

30. The system of claim 23, wherein the predetermined certain event is a conditional event that occurs when a desired condition is satisfied.

31. The system of claim 30, wherein the conditional event is based on at least one of (i) a desired position of the mobile terminal, (ii) desired content being executed on the mobile terminal, and (iii) a desired time reached by the mobile terminal, and the event detecting module is further configured to:
determine that (i) the mobile terminal is in a vicinity of the desired position, (ii) the desired content is executed on the mobile terminal, and (iii) the mobile terminal has reached the desired time.

32. A server configured to provide, to a mobile terminal, an application for obtaining an advertisement based on an event occurrence, the application causing the mobile terminal to,
determine that a desired event has occurred on the mobile terminal;
generate event occurrence information, the event occurrence information being associated with the desired event;
extract a keyword based on the generated event occurrence information; and
obtain the advertisement from the server, the obtained advertisement being based on the extracted keyword.
